(19) United States
(12) Patent Application Publication
(10) Pub. No.: US 2017/0082262 A1
(43) Pub. Date: Mar. 23, 2017

(54) OPTICAL DEVICE AND LIGHTING APPARATUS INCLUDING THE SAME

(71) Applicant: SAMSUNG ELECTRONICS CO., LTD., Suwon-si (KR)

(72) Inventors: Seung Gyun JUNG, Hwaseong-si (KR); Jun CHO, Yongin-si (KR); Won Soo JI, Hwaseong-si (KR)

(73) Assignee: SAMSUNG ELECTRONICS CO., LTD., Suwon-si (KR)

(21) Appl. No.: 15/072,499

(22) Filed: Mar. 17, 2016

(30) Foreign Application Priority Data
Sep. 17, 2015 (KR) 10-2015-0131426

(51) Int. Cl. F21V 5/04; F21V 23/00; F21V 23/02; F21V 3/00

(52) U.S. Cl. CPC F21V 5/04; F21V 3/00; F21V 23/005; F21V 23/001; F21V 23/02; F21Y 2115/10

(57) ABSTRACT

An exemplary embodiment discloses a lighting apparatus including: a base; a first light emitting device (LED) array disposed on the base; a second LED array disposed on the base; and an optical device disposed on the base, the optical device including: a first lens covering the first LED array; and a second lens covering the second LED array, wherein a first beam angle of the first lens is different from a second beam angle of the second lens.

### CROSS-REFERENCE TO RELATED APPLICATION

This application claims priority from Korean Patent Application No. 10-2015-0131426 filed on Sep. 17, 2015, with the Korean Intellectual Property Office, the disclosure of which is incorporated herein by reference in its entirety.

### BACKGROUND

1. Field

Apparatuses consistent with exemplary embodiments relate to an optical device and a lighting apparatus including the same. More specifically, the exemplary embodiments relate to an optical device configured to improve brightness distribution of light from one or more sources of light, and a lighting apparatus including the same.

2. Description of the Related Art

Circular fluorescent lamps of the related art are utilized in various lighting environments (e.g., home, office, industrial, etc.) because the circular fluorescent lamps may radiate light evenly in all directions. In this manner, traditional fluorescent lamps may provide natural lighting environments in indoor spaces by supplying substantially uniform light intensity via a suitable lighting apparatus (e.g., supporting ballast structure). It is noted, however, that the configuration of ballasts of the related art may inhibit the ability of circular fluorescent lamps to uniformly radiate light therefrom.

FIG. 1 is an exploded view of a lighting apparatus 10 of the related art including a circular fluorescent lamp 12. The circular fluorescent lamp 12 is disposed on a first (e.g., lower) surface of a base 13. A light diffuser 11 covers the circular fluorescent lamp 12. In this manner, a second (e.g., upper) surface of the base 13 may be attached (or otherwise coupled) to a suitable installation surface, such as, for example, a ceiling, a wall, etc., surface. Although not illustrated, the base 13 may also include additional components, such as, for example, a power supply configured to supply power to the fluorescent lamp 12 and a control circuit configured to control operation of the power supply, and, thereby, to control the excitation of the fluorescent lamp 12. The light diffuser 11 may diffuse the light radiating from the fluorescent lamp 12, which may soften light emitted from the lighting apparatus 10.

FIG. 2 is a perspective view of the lighting apparatus 10 of the related art coupled to a ceiling 20. As previously mentioned, the lighting apparatus 10 includes the circular fluorescent lamp 12, and, thereby, may evenly radiate light. That is, as seen in FIG. 2, lighting apparatus may evenly diffuse light in all directions as illustrated by the arrows pointing away from the circular fluorescent lamp 12.

It is noted that a center 11a of the light diffuser 11 is spaced apart from internal side 12a of the circular fluorescent lamp 12, and, therefore, a dark spot may appear around the center 11a of the light diffuser 11, which is described in more detail in association with FIG. 3. Further, an additional lamp may not be included in the center of the lighting apparatus 10 because additional components, such as the aforementioned power supply and control circuit, are typically disposed in the center region of the base member 13.

FIG. 3 illustrates the result of a simulation demonstrating the spatial distribution in the intensity of light emitting from the conventional lighting apparatus 10. Referring to FIG. 3, according to the prior art, the spatial distribution in the intensity of light includes a dark spot in a central region corresponding to the center 11a of the light diffuser 11. The spatial distribution has a maximum light intensity greater than 6000 lux. But it also shows that the light intensity is approximately 3000 lux at the center 11a of the light diffuser 11. Accordingly, the light intensity at the center of the lighting apparatus 10 including the circular fluorescent lamp 12 of the related art lacks uniformity in light intensity, and, therefore, may not provide sufficient performance in a lighting environment, such as an indoor lighting environment. To this end, the lighting apparatus 10 may not provide sufficient light to an area located directly below the central region of the lighting apparatus 10.

Optical semiconductor devices may be included in a lighting apparatus for indoor and outdoor use in lieu of the fluorescent lamp 12. A lighting apparatus including such optical semiconductor devices may exhibit relatively high light efficiency and low power consumption. Optical semiconductor device includes, for example, a light emitting device (LED). It is noted that a number of the LEDs may be disposed on the first surface of the base 13 in a circular formation in place of circular fluorescent lamp 12. The LEDs disposed in the circular formation may provide greater light intensity than the circular fluorescent lamp 12.

Even still, a lighting apparatus including such LEDs in a circular formation still exhibit a dark spot in a central region of the lighting apparatus. Furthermore, the LEDs are relatively small devices with smaller illumination areas as compared to circular fluorescent lamp 12, and, therefore, light generated by the LEDs exhibit a relatively narrower beam angle. As such, a lighting apparatus including the LEDs arranged in a circular formation may exhibit a relatively greater dark spot area and a relatively greater maximum light intensity as compared to the circular fluorescent lamp 12. Thus, such light devices may not supply a sufficiently uniform light intensity.

The above information disclosed in this Background section is only for enhancement of understanding of the background of the inventive concept.

### SUMMARY

One or more exemplary embodiments provide a lighting apparatus configured to supply substantially uniform light intensity.

One or more exemplary embodiments also provide an optical device configured to control light radiated from light source to supply substantially uniform light intensity.

Additional aspects will be set forth in the detailed description which follows, and, in part, will be apparent from the disclosure, or may be learned by practice of the inventive concept.

An exemplary embodiment discloses a lighting apparatus including: a base; a first light emitting device (LED) array disposed on the base; a second LED array disposed on the base; and an optical device disposed on the base, the optical device including: a first lens disposed in association with the first LED array; and a second lens disposed in association with the second LED array, wherein beam angles of the first and second lenses are different from one another.

An exemplary embodiment also discloses an optical device for a lighting apparatus including: a first lens portion; a second lens portion; and a plate portion connecting the first and second lenses, wherein beam angles of the first and second lenses are different from one another.

According to an aspect of an exemplary embodiment, there is provided a lighting apparatus, including: a base; a first light emitting device (LED) array disposed on the base; a second LED array disposed on the base; and an optical device disposed on the base, the optical device including: a first lens covering the first LED array; and a second lens covering the second LED array, wherein a first beam angle of the first lens is different from a second beam angle of the second lens.

The first LED array may surround a central region of the base. The second LED array may be spaced apart from the first LED array and surrounds the first LED array. The first lens may include: a first incidence surface configured to receive light radiated from the first LED array; and a first refraction surface configured to refract light propagating from the first incidence surface; and the second lens may include: a second incidence surface configured to receive light radiated from the second LED array; and a second refraction surface configured to refract light propagating from the second incidence surface.

The second beam angle of the second lens may be greater than the first beam angle of the first lens.

The first refraction surface may include a first effective refraction surface. The second refraction surface may include a second effective refraction surface; and the first effective refraction surface and the second effective refraction surface may be configured to refract light toward the central region of the lighting apparatus.

The first effective refraction surface may form an angular range of 40° from a first reference point toward a center point of the first lens, the second effective refraction surface may form an angular range of 50° from a second reference point toward a center point of the second lens, the first reference point corresponds to an intersection point between the first refraction surface and a first plate portion of the optical device; and the second reference point corresponds to an intersection point between the second refraction surface and a second plate portion of the optical device.

The first plate portion may be provided between the central region and the first lens; and the second plate portion may be provided between the first lens and the second lens.

A radius of curvature of the first effective refraction surface may be between 2 mm and 6 mm; and a radius of curvature of the second effective refraction surface may be between 2.4 mm and 5.5 mm.

A radius of curvature of the first incidence surface may be between 1.5 mm and 2.5 mm; and a radius of curvature of the second incidence surface may be between 1.5 mm and 2 mm.

The lighting apparatus may further include light diffusing particles disposed on the first refraction surface and the second refraction surface, wherein the light diffusing particles may be disposed outside the first effective refraction surface and the second effective refraction surface along a radial direction of the optical device.

A size of the light diffusing particles may be less than or equal to 20 μm.

The first beam angle of the first lens with respect to a first center line may be different from the second beam angle of the second lens with respect to a second center line; the first centerline may extend in a direction from a center of an LED of the first LED array through a center of the first lens; and the second centerline may extend in a direction from a center of an LED of the second LED array through a center of the second lens.

The first beam angle of the first lens with respect to a first center line may be different from the second beam angle of the second lens with respect to a second center line; and the first center line and the second center line may extend in a parallel direction with each other.

According to an aspect of an exemplary embodiment, there is provided a lighting apparatus, including: a base; a first light emitting device (LED) array disposed on the base; a second LED array disposed on the base; and an optical device disposed on the base, the optical device including: a first lens covering the first LED array, the first lens including: a first incidence surface configured to receive light radiated from the first LED array; and a first refraction surface configured to refract light propagating from the first incidence surface; and a second lens covering the second LED array, the second lens including: a second incidence surface configured to receive light radiated from the second LED array; and a second refraction surface configured to refract light propagating from the second incidence surface, wherein a first beam angle of the first lens and a second beam angle of the second lens are different from each other by independently controlling radii of the first incidence surface and the first refraction surface, and radii of the second incident surface and the second refraction surface, respectively.

According to an aspect of an exemplary embodiment, there is provided an optical device, including: a first lens portion; a second lens portion; a first plate portion provided between the first lens portion and the second lens portion, wherein a beam angle of the first lens portion and a beam angle of the second lens portion are different from each other.

The first lens portion may be configured to cover a first light source, the first lens portion including: a first incidence surface configured to receive light radiated from the first light source; and a first refraction surface configured to refract light propagating from the first incidence surface; and the second lens portion is configured to cover a second light source, the second lens portion including: a second incidence surface configured to receive light radiated from the second light source; and a second refraction surface configured to refract light propagating from the second incidence surface.

The second beam angle of the second lens portion is greater than the first beam angle of the first lens.

The first refraction surface may include a first effective refraction surface; the second refraction surface may include a second effective refraction surface; and the first effective refraction surface and the second effective refraction surface may be configured to refract light toward a central region of the plate portion.

The first effective refraction surface may correspond to a portion of the first refraction surface with an angular range of 40° from a first reference point; and the second effective refraction surface may correspond to a portion of the first refraction surface with an angular range of 50° from a second reference point.

The optical device may further include a second plate portion provided between the central region and the first lens portion, wherein: the first reference point corresponds to an intersection point between the first refraction surface and the first plate portion of the optical device; and the second reference point corresponds to an intersection point between the second refraction surface and the second plate portion of the optical device.

The first plate portion may include: a first thickness at a first reference point, wherein the first plate portion and the first lens portion are connected to each other at the first reference point; and a second thickness at a second reference point, wherein the first plate portion and the second lens are connected to each other at the second reference point, wherein the first thickness may be different from the second thickness.

The first thickness may be greater than the second thickness.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is an exploded view of a lighting apparatus of the related art;

FIG. 2 is a perspective view of the lighting apparatus of the related art of FIG. 1;

FIG. 3 illustrates results of a simulation demonstrating the spatial distribution in the intensity of light generated by the lighting apparatus of the related art of FIGS. 1 and 2;

FIG. 4 is an exploded view of a lighting apparatus, according to an exemplary embodiment;

FIG. 5 is a perspective view of an optical device of the light apparatus of FIG. 4, according to an exemplary embodiment;

FIG. 6 is a cross-sectional view of the optical device of FIG. 5 taken along sectional line I-I′, according to an exemplary embodiment;

FIG. 7 is a conceptual diagram of the operation of the lighting apparatus of FIGS. 5 and 6, according to an exemplary embodiment;

FIGS. 8A and 8B are plots illustrating the distribution of light in association with first and second lenses, respectively, of the optical device of FIGS. 5 and 6, according to exemplary embodiments;

FIGS. 9 and 10 are respective cross-sectional views of optical devices, according to exemplary embodiments; and

FIG. 11 illustrates results of a simulation demonstrating the spatial distribution in the intensity of light generated by the lighting apparatus of FIGS. 4 and 5, according to exemplary embodiments.

### DETAILED DESCRIPTION

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to plan and/or sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

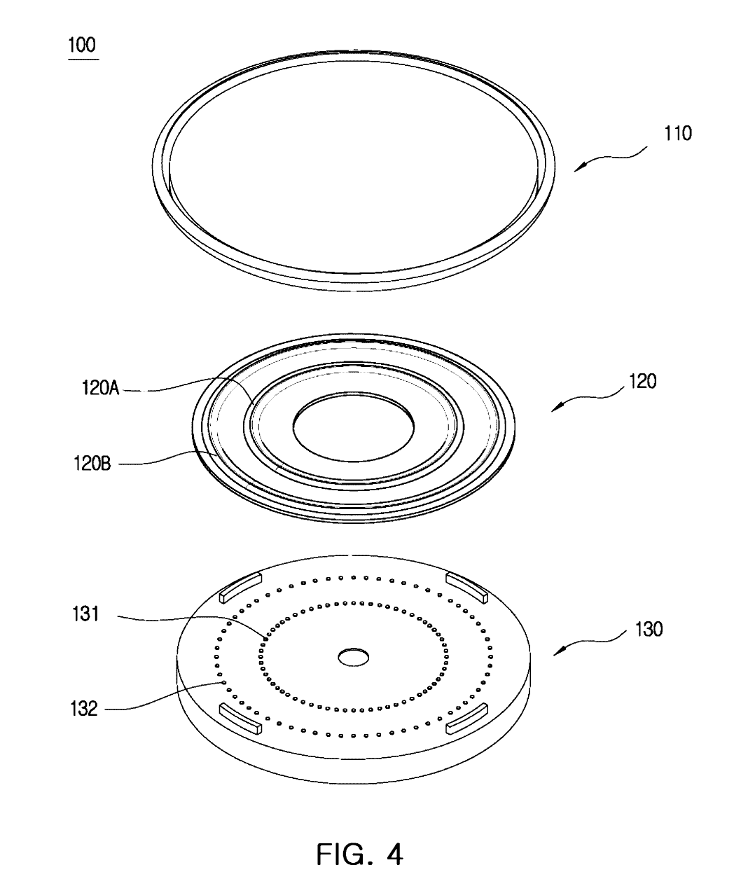

FIG. 4 is an exploded view of a lighting apparatus 100 according to an exemplary embodiment. Referring to FIG. 4, the lighting apparatus 100 may include a light diffuser 110, an optical device 120, and a base 130.

The light diffuser 110 may be configured to diffuse the light radiating from the light source such as LEDs included in the lighting apparatus 100 and provide “natural” environment. The light diffuser 110 may be generally formed of any suitable material, such as, for example, translucent acrylic material including at least one of, but not limited to, poly methyl methacrylate (PMMA), polycarbonate (PC), and polyethylene terephthalate (PET), etc.

The light diffuser 110 may be disposed to completely cover the light source to diffuse direct light radiated from the light source. Therefore, a circular shape of the light diffuser 110 illustrated in FIG. 4 is merely an exemplary illustration, and the light diffuser 110 may have various shapes including, but not limited to, a polygonal shape including a rectangular shape, a pentagon shape, and a hexagon shape, and an arch shape. The light diffuser 110 may have improved light diffusing effect by adjusting the size, thickness and transparency of the light diffuser. The light diffuser 110 may have various size and thickness depending on the light intensity of the source.

Furthermore, the light diffuser 110 may have improved light diffusing effect as the surface has increased roughness and reduced reflectance. Therefore, to increase the light diffusing effect, grooves (not shown) may be formed on the surface of the light diffuser 110, light diffusing particles (not shown) may be disposed on the surface of the light diffuser 110, and a light diffusing film (not shown) may be adhered on to the surface of the light diffuser 110. The light diffusing particles (not shown) may include micro-holes, which may be made of the same material as forming the light diffuser 110, and the light diffusing film may also be made of the same material as forming the light diffuser 110. The exemplary embodiments are not limited thereto, and may have any structure or made of any material that may provide light diffusing effect.

Referring to FIG. 4, the base 130 may include a first (e.g., a lower) surface and a second (e.g., an upper) surface. The first surface of the base 130 may include the light source, such as LEDs disposed thereon, and the second surface of the base 130 may be attached to an indoor building structure such as the ceiling or the wall. The second surface of the base 130 may be directly attached to the indoor building structure, or may be indirectly attached to the indoor building structure using additional fixtures such as support structure. The base 130 may be made of metal material, but the exemplary embodiments are not limited thereto, and may be made of various material. The base 130 may include the light sources such as the LEDs, additional components including the power supply to provide power to the light source and the control circuit, and electric wires interconnecting them disposed on the first surface of the base 130. More specifically, considering the connection efficiency, the light sources such as the LEDs, the power supply, the control circuit, and the electric wires may be disposed at the center of the first surface of the base 130.

Therefore, the LEDs may be disposed surrounding the center of the first surface of the base 130. When LEDs are used as light sources, a number of LEDs are disposed on the base 130 to provide sufficient light intensity and proper coverage.

Referring to FIG. 4, LEDs may be disposed to form a first LED array 131 and a second LED array 132. The first LED array 131 and the second LED array 132 illustrated in FIG. 4 have concentric circular shapes, but the exemplary embodiments are not limited thereto, and the first LED array 131 and the second LED array 132 may have various shapes as previously discussed above.

In the exemplary embodiment, each of the first LED array 131 and the second LED array 132 may include a plurality of LEDs disposed with respective distances from the center of the base 130 in the concentric circular shapes. Accordingly, the lighting apparatus may radiate light evenly in all direction, and therefore, may provide natural environment in indoor by supplying substantially uniform light intensity similar to the circular fluorescent lamp. However, the distribution shape of the first and second LED arrays 131 and 132 need not to be in a circular shape, and the first and second LED arrays 131 and 132 may have any closed curve or polygon surrounding the center of the base 130. Therefore, the first and second LED arrays may be disposed forming a polygonal shape including, but not limited to, a triangular shape, a rectangular shape, and a pentagonal shape, or an oval shape. Furthermore, the distribution shapes of the first and second LED arrays are not limited to closed curve or polygon surrounding the center of the base 130, and may be linear shapes.

The exemplary embodiment illustrated in FIG. 4 includes two (2) LED arrays 131 and 132, but the exemplary embodiments are not limited thereto, and may include any number of LED arrays in response to design factors including the area of the space that the lighting apparatus 100 illuminates and luminance requirement.

Each LED of the plurality of LEDs included in the first and second LED arrays may radiate light having a narrow light distribution angle due to the optical property of LED. Therefore, in order to use LED as light source of lighting apparatus, the lighting apparatus may generally include an optical device such as an optical lens. According to the exemplary embodiments of the disclosure, the optical device may refract the light radiated from the LED in various ways so that the lighting apparatus may provide light with sufficient light distribution angle.

Referring to FIG. 4, the lighting apparatus 100 includes an optical device 120 including a first lens 120A and a second lens 120B respectively corresponding to the first LED array 131 and the second LED array 132. That is, the first lens 120A covers the first LED array and the second lens 120B covers the second LED array 132 as shown in FIG. 4.

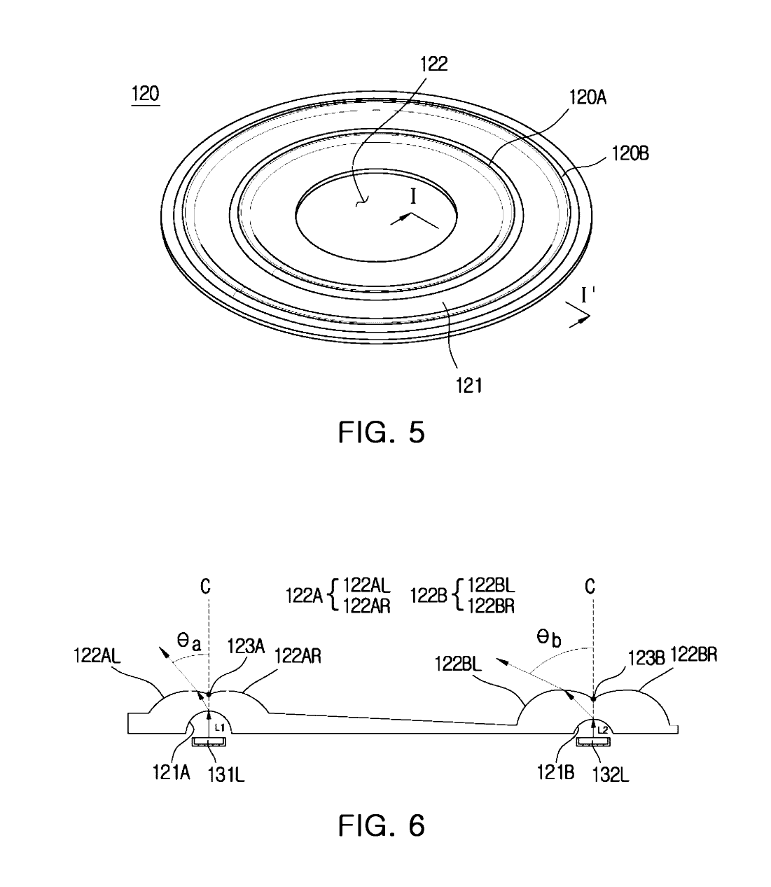

FIG. 5 is a perspective view of an optical device 120 of the lighting apparatus of FIG. 4, according to an exemplary embodiment. Referring to FIG. 5, the optical device 120 includes the first lens 120A, the second lens 120B, and a plate portion 121. The first lens 120A may have a circular shape surrounding the center of the optical device 120. The second lens 120B may have a circular shape surrounding the first lens 120A at a fixed distance from the first lens 120A. However, the exemplary embodiments are not limited thereto, and the first and second lenses 120A and 120B may have various shapes and positions corresponding to the shape of the first and second LED arrays 131 and 132 which may have a polygonal shape including, but not limited to, a triangular shape, a rectangular shape, and a pentagonal shape, or an oval shape.

The first lens 120A, the second lens 120B, and the plate portion 121 may be integrally formed of the same material. The first lens 120A, the second lens 120B may be formed of transparent material that may be used for LED lens. For example, the first lens 120A and the second lens 120B may be formed of PMMA, PC, and/or glass, considering design factors including refractive index of the lens.

When the first lens 120A, the second lens 120B, and the plate portion 121 are integrally formed, the optical device 120 may be formed by a molding method. The optical device 120 may be made from same material, or the first and second lenses 120A and 120B may be separately manufactured and combined with the plate portion 121.

The plate portion 121 may have an opening 122 in the center, so that the additional components including power supply disposed in the center of the base 130 may be exposed through the opening 122, and therefore, the optical device 120 may be substantially affixed to the base 130. The opening 122 may have various shapes and positions corresponding to the additional components disposed in the center of the base 130.

The optical device 120 may be configured to control the light distribution angle of the LEDs, and may also cover the LEDs providing protections to the LEDs against the external environment.

The positions and the shapes of the first lens 120A and the second lens 120B respectively corresponds to the positions and the shapes of the first LED array 131 and the second LED array 132. Accordingly, the optical device 120 may also include more lenses such as a third lens (not shown) and a fourth lens (not shown) in response to additional number of LED arrays, such as a third array (not shown) and a fourth array (not shown).

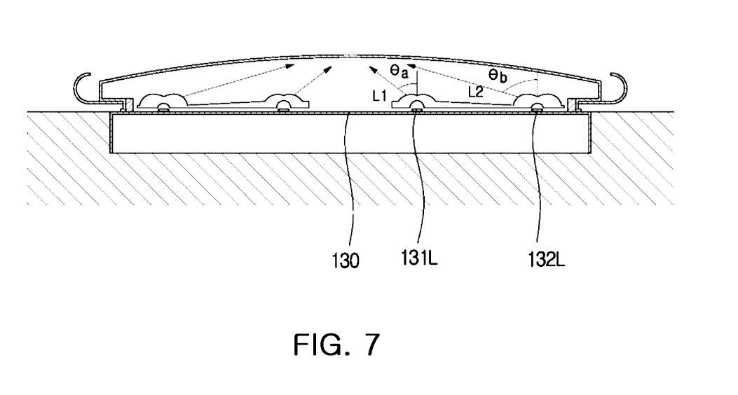

FIG. 6 is a cross-sectional view of the optical device 120 of FIG. 5 taken along a sectional line I-I′, according to exemplary embodiments. As seen in FIG. 6, the first lens 120A includes a first incidence surface 121A and a first refraction surface 122A, and the second lens 120B includes a second incidence surface 121B and a second refraction surface 122B. The first refraction surface 122A of the first lens 120A may include a left refraction surface 122AL and a right refraction surface 122AR with respect to a center 123A of the first lens 120A. The second refraction surface 122B of the first lens 120B may include a left refraction surface 122BL and a right refraction surface 122BR with respect to a center 123B of the second lens 120B. The first lens 120A and the second lens 120B may respectively refract a first light L1 radiating from a first LED 131L and a second light L2 radiating from a second LED 132L, respectively, in various angles. The first light L1 radiating from the first LED 131L may be first refracted at the first incidence surface 121A, and may be subsequently refracted at the first refraction surface 122A. The second light L2 radiating from the second LED 132L may be first refracted at the second incidence surface 121B, and be subsequently refracted at the second refraction surface 122B.

The first lens 120A may be configured to refract the first light L1 to have a first beam angle θₐ with respect to a center line C, and the second lens 120B may be configured to refract the second light L2 to have a second beam angle θ_{b} with respect to a center line C. The beam angle may refer to an angle formed by the refracted light by the lens with respect to the center line C. Here, the center lines C of the first and the second lenses correspond to a line extending from the center of the first and the second LEDs, respectively, extending in a normal direction from a light emitting surface of each of the first and the second LEDs.

The beam angles of the first and second lenses 120A and 120B may be designed by controlling radii of curvature of the first and second incidence surfaces 121A and 121B and the first and second refraction surfaces 122A and 122B, respectively. The beam angle generally increases as the radius of curvature of the lens is increased, but the beam angle is not proportional to the radii of curvature of the first and second incidence surfaces 121A and 121B when each of the radii of curvature of the first and second incidence surfaces 121A and 121B are independently controlled. The beam angle may be calculated based on law of physics including the Snell's law.

According to the exemplary embodiment, the lighting apparatus 100 may have two different beam angles including the first beam angle θₐ of the first lens 120A and the second beam angle θ_{b} of the second lens 120B. Referring to FIG. 6, the first beam angle θₐ of the first lens 120A may be smaller than the second beam angle θ_{b} of the second lens 120B.

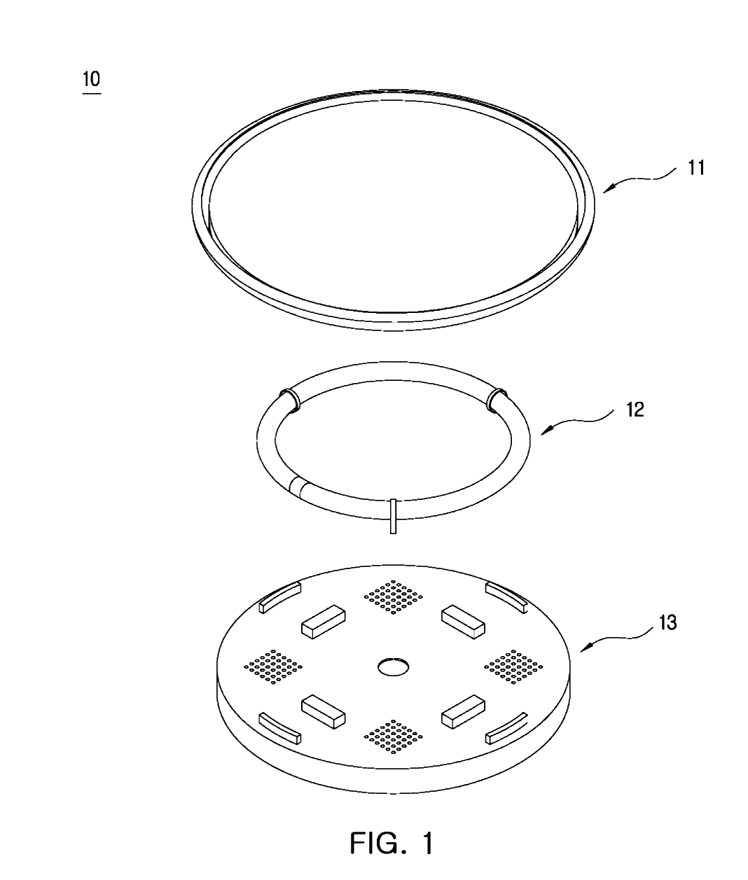

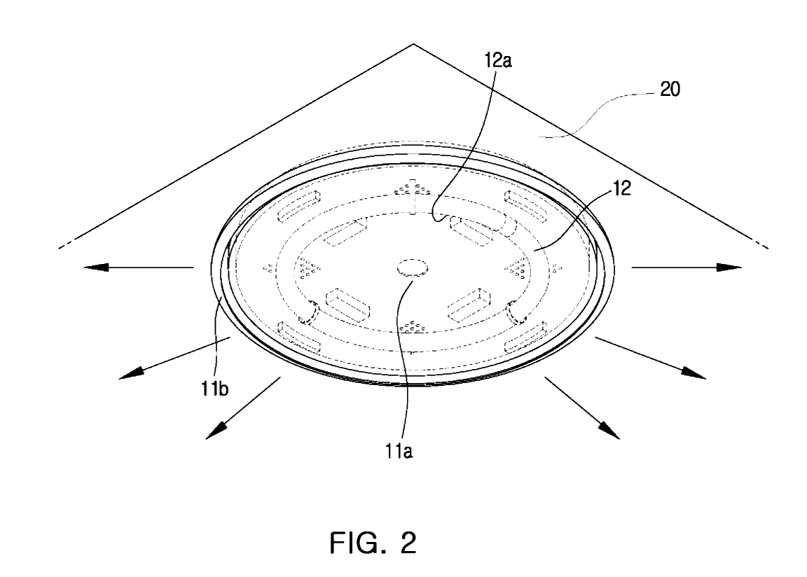

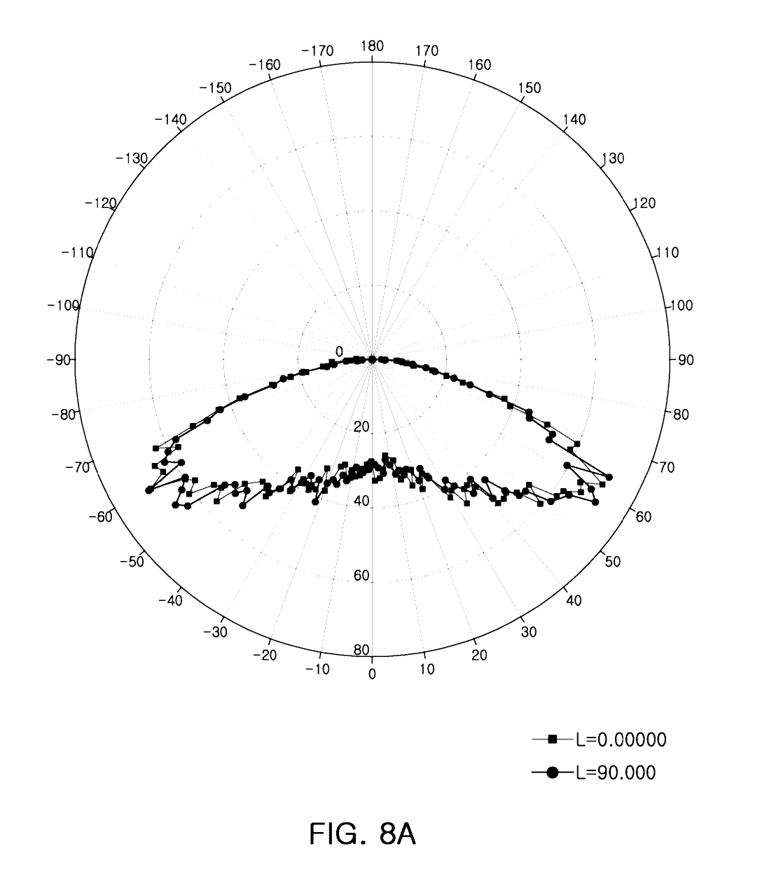

FIG. 7 is a conceptual diagram of the operation of the lighting apparatus of FIGS. 1 and 2, according to an exemplary embodiment. Referring to FIG. 7, the first light L1 radiated from the first LED 131L disposed on the base 130 may be refracted at the first incidence surface 121A and the first refraction surface 122A of the first lens 120A, and may propagate within the first beam angle θₐ. The first beam angle θₐ may be controlled so that the first light L1 may be directed toward the center of the light diffuser 110. The second light L2 radiated from the second LED 132L disposed on the base 130 may be refracted at the second incidence surface 121B and the second refraction surface 122B of the second lens 120B, and may propagate within the first beam angle θ_{b}. The second beam angle θ_{b} may be controlled so that the second light L2 may be directed toward the center of the light diffuser 110.

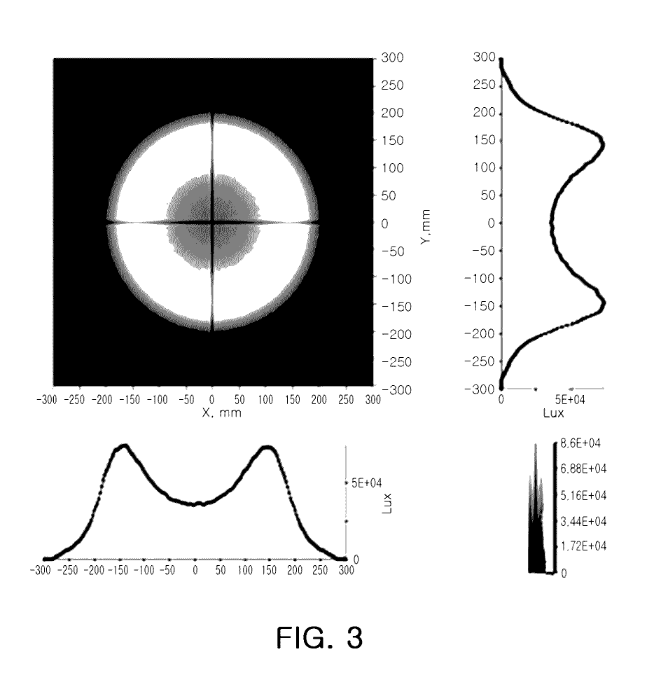

Accordingly, by configuring the first lens 120A and the second lens 120B to have different beam angles θₐ and θ_{b}, respectively, sufficient light may be provided toward the center of the light diffuser 110. Therefore, the dark spot in the center of the light diffuser 110 of the related art as disclosed in FIGS. 1 through 3 may be reduced or eliminated.

The first lens 120A and the second lens 120B may be configured to have different beam angles θₐ and θ_{b} by controlling the respective first and second incidence surfaces 121A and 121B and the respective first and second refraction surfaces 122A and 122B. However, the exemplary embodiments are not limited thereto, and the beam angles θₐ and θ_{b} may be controlled by structural changes.

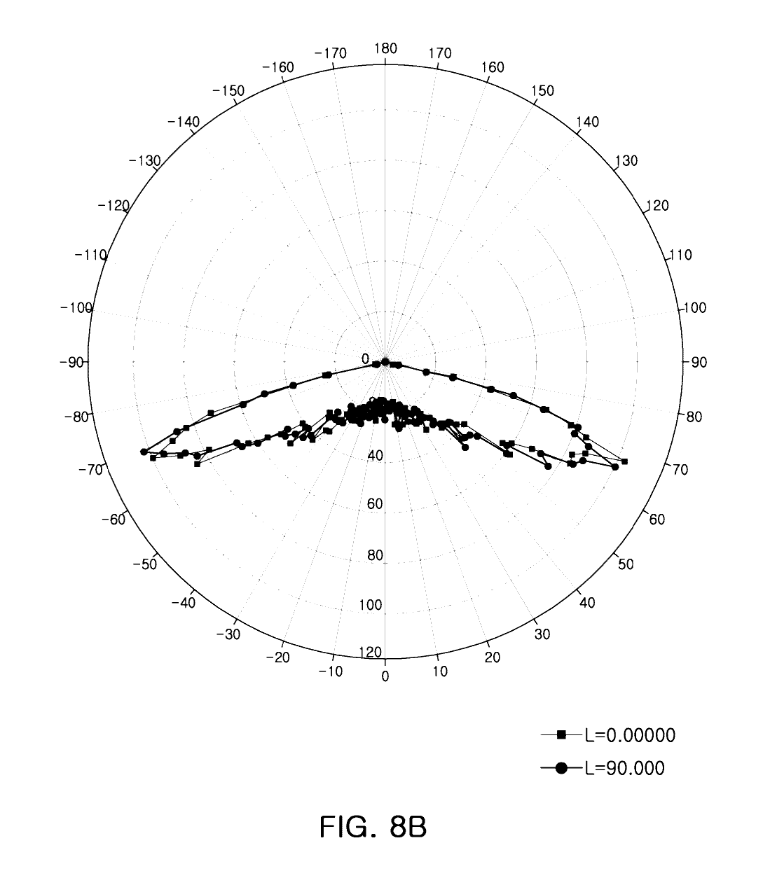

FIGS. 8A and 8B are plots illustrating a distribution of light in association with the first lens 120A and the second lens 120B of the optical device 120 included in the lighting apparatus 100, according to an exemplary embodiment.

According to the exemplary embodiment illustrated in FIG. 8A, the first light L1 may have a beam angle of substantially between 0° and 60° on either side with respect to the center line, and may have a light distribution angle of substantially 120°. Referring to FIG. 8A, the first light L1 may have maximum light intensity at the beam angle substantially between 55° and 60° on either side with respect to the center line C.

According to the exemplary embodiment illustrated in FIG. 8B, the second light L2 may have a beam angle of substantially between 0° and 80° on either side with respect to the center line, and may have a light distribution angle of substantially 160°. Referring to FIG. 8B, the second light L2 may have maximum light intensity at the beam angle substantially between 70° and 80° on either side with respect to the center line.

Accordingly, each of the first lens 120A and the second lens 120B may provide the first light L1 and the second light L2, respectively, having different beam angles to provide sufficient light toward the center of the light diffuser 110, and thus, the lighting apparatus 100 may supply substantially uniform light intensity by reducing or eliminating the dark spot.

The exemplary embodiment in FIGS. 8A and 8B are illustrative examples, and the exemplary embodiments are not limited thereto. The range of beam angles and light intensities of the respective lenses may be configured considering design factors including the distance between the two lenses and light intensity of the light source.

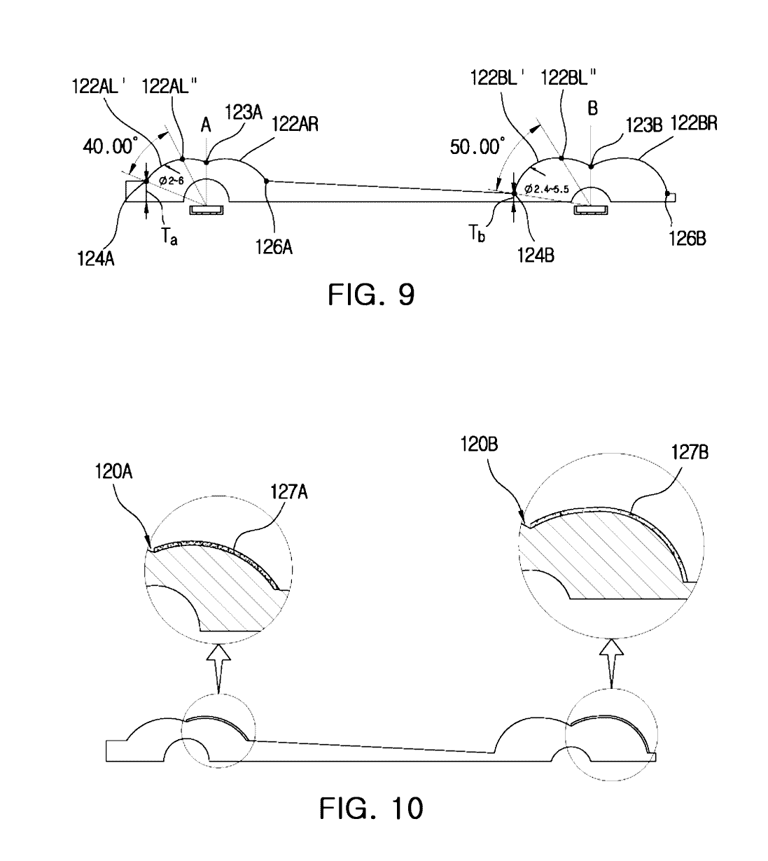

FIG. 9 illustrates a cross-sectional view of an optical device according to an exemplary embodiment. Referring to FIGS. 6 and 9, the first refraction surface 122A of the first lens 120A may include a left refraction surface 122AL and a right refraction surface 122AR with respect to a center 123A of the first lens 120A. The left refraction surface 122AL may be defined as a part of the first refraction surface 122A disposed between a left reference point 124A, at which the left side of the first refraction surface 122A meets the plate portion 121, and the center 123A. The right refraction surface 122AR may be defined as a part of the first refraction surface 122A disposed between the right reference point 126A, at which the right side of the first refraction surface 122A meets the plate portion 121, and the center 123A. FIGS. 6 and 9 shows that the left refraction surface 122AL and the right refraction surface 122AR of the first refraction surface 122A may be symmetrical, but exemplary embodiments are not limited thereto. According to exemplary embodiments, the left refraction surface 122AL and the right refraction surface 122AR of the first refraction surface 122A may be asymmetrical.

According to the exemplary embodiment, the left refraction surface 122AL may have a radius of curvature of substantially between 2 mm to 6 mm, and the first incidence surface 121A may have a radius of curvature of substantially between 1.5 mm to 2.5 mm. However, the exemplary embodiments are not limited thereto, and may have different radius of curvature in connection with the incidence surface. Furthermore, the left refraction surface 122AL may include an effective refraction surface 122AL′. The effective refraction surface 122AL′ may be defined as a part of the left refraction surface 122AL disposed within an angle between the left reference point 124A to an effective refraction point 122AL″, and the light radiating through the effective refraction surface 122AL′ is directed toward the center of the light diffuser 110. Referring to exemplary embodiment, the effective refraction surface 122AL′ of the first lens 120A may be defined with an angular range of substantially 40° from the left reference porting 124A. The exemplary embodiments are not limited thereto, and the angular range may vary according to an area of the center of the light diffuser 110.

Referring to FIGS. 6 and 9, similar to the first lens 120A, the second refraction surface 122B of the second lens 120B may include a left refraction surface 122BL and a right refraction surface 122BR with respect to a center 123B of the second lens 120B. The left refraction surface 122BL may be defined as a part of the second refraction surface 122B disposed between a left reference point 124B, at which the left side of the second refraction surface 122B meets the plate portion 121, and the center 123B. The right refraction surface 122BR may be defined as a part of the second refraction surface 122B disposed between the right reference point 126B, at which the right side of the second refraction surface 122B meets the plate portion 121, and the center 123B. FIGS. 6 and 9 shows that the left refraction surface 122BL and the right refraction surface 122BR of the second refraction surface 122B may be symmetrical, but exemplary embodiments are not limited thereto. According to exemplary embodiments, the left refraction surface 122BL and the right refraction surface 122BR of the second refraction surface 122B may be asymmetrical.

According to the exemplary embodiment, the left refraction surface 122BL may have a radius of curvature of substantially between 2.4 mm to 5.5 mm, and the second incidence surface 121B may have a radius of curvature of substantially between 1.5 mm to 2 mm. However, the exemplary embodiments are not limited thereto, and may have different radius of curvature in connection with the incidence surface. Furthermore, the left refraction surface 122BL may include an effective refraction surface 122BL′. The effective refraction surface 122BL′ may be defined as a part of the left refraction surface 122BL disposed within an angle between the left reference point 124B to a effective refraction point 122BL″, and the light radiating through the effective refraction surface 122BL′ is directed toward the center of the light diffuser 110. Referring to exemplary embodiment, the effective refraction surface 122BL′ of the second lens 120B may be defined with an angular range of substantially 50° from the left reference point 124B. The exemplary embodiments are not limited thereto, and the angular range may vary depending on an area of the center of the light diffuser 110.

Referring to FIG. 9, the plate portion 121 may be configured to have a first thickness Tₐ at the left reference point 124A of the first lens 120A and a second thickness T_{b} at the left reference point 124B of the second lens 120B, the first thickness Tₐ to be thicker than the second thickness T_{b}. Accordingly, the effective refraction surface 122BL′ of the second lens 120B may have area larger than that of the effective refraction surface 122AL′ of the first lens 120A, and therefore, the beam angle θ_{b} of the second lens 120B may be greater than the beam angle θₐ of the first lens 120A. Accordingly, the dark spot of the light diffuser 110 may be reduced.

FIG. 10 is a cross-sectional view of an optical device, according to exemplary embodiments. Referring to FIG. 10, the optical device according to the exemplary embodiments may include additional diffusion treatment. More specifically, the right refraction surface 122AR of the first lens 120A and the right refraction surface 122BR of the second lens 120B may respectively include diffusion treatments 127A and 127B. Accordingly, the light propagating toward the edge of the light diffuser 110 may be diffused, and difference in the light intensity with the center of the light diffuser 110 may be reduced.

When the first and second LED arrays 131 and 132 are disposed closer to the edge of the light diffuser 110 than the center of the light diffuser 110, the lighting apparatus 100 may provide substantially uniform light intensity by providing diffusion treatments 127A and 127B respectively on the right refraction surfaces 122AR and 122BR. The diffusion treatment may be formed by applying light diffusing particles including micro-holes, the light diffusing particles made of polymer compound such as polycarbonate. The light diffusing particles may have a size less than or equal to 20 μm. However, the exemplary embodiments are not limited thereto, and the diffusion treatments may selectively be provided onto the incidence surface.

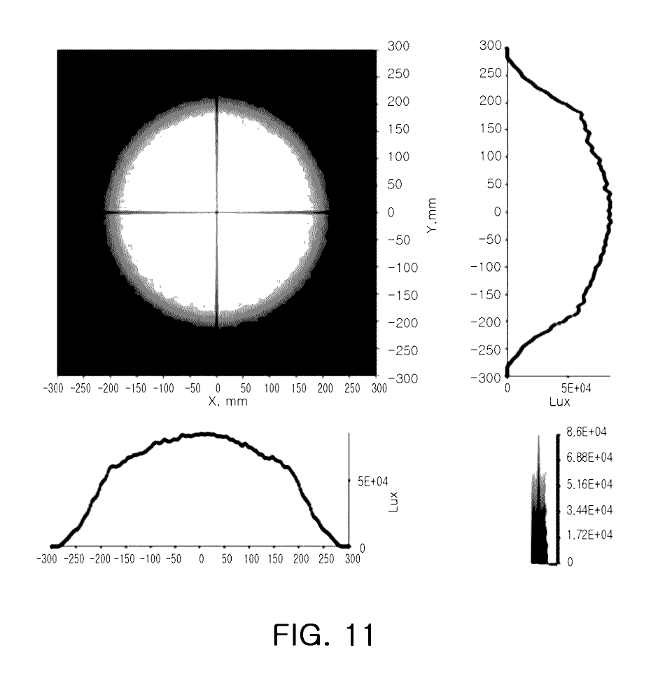

FIG. 11 illustrates the results of a simulation demonstrating the spatial distribution in the intensity of the light generated by the lighting apparatus of FIGS. 4 and 5, according to the exemplary embodiments. As seen in FIG. 11, the simulation uses data corresponding radii of curvature of the refraction surfaces and incidence surfaces and diffusion particles having a size substantially less than or equal to 20 μm applied to the right refraction surfaces, e.g., surfaces 127A and 127B.

Referring to FIG. 11, the lighting apparatus 100 provides light intensity which is greatest in the center of the light diffuser 110 and gradually decreases toward the edge of the light diffuser 110. According to the simulation results, the lighting apparatus 100 provides relatively uniform illuminance between substantially 85000 Lux and 50000 Lux. Accordingly, the lighting apparatus 100 may provide relatively uniform light intensity from the light diffuser 110 without providing additional LED arrays. This may improve the lighting apparatus 100 and save the manufacturing cost by reducing the number of LEDs. To this end, light emitted by lighting apparatus 100 may provide a more “natural” light environment than conventional light devices, such as the light apparatus of FIGS. 1 and 2.

While exemplary embodiments have been particularly shown and described herein, it will be apparent to those skilled in the art that modifications and variations could be made therein without departing from the scope of the inventive concept as defined by the following claims.

1. A lighting apparatus, comprising:
a base;
a first light emitting device (LED) array disposed on the base;
a second LED array disposed on the base; and
an optical device disposed on the base, the optical device comprising:
a first lens covering the first LED array; and
a second lens covering the second LED array,
wherein a first beam angle of the first lens is different from a second beam angle of the second lens.

2. The lighting apparatus of claim 1, wherein:
the first LED array surrounds a central region of the base;
the second LED array is spaced apart from the first LED array and surrounds the first LED array;
the first lens comprising:
a first incidence surface configured to receive light radiated from the first LED array; and
a first refraction surface configured to refract light propagating from the first incidence surface; and
the second lens comprising:
a second incidence surface configured to receive light radiated from the second LED array; and
a second refraction surface configured to refract light propagating from the second incidence surface.

3. The lighting apparatus of claim 2, wherein the second beam angle of the second lens is greater than the first beam angle of the first lens.

4. The lighting apparatus of claim 2, wherein:
the first refraction surface comprises a first effective refraction surface;
the second refraction surface comprises a second effective refraction surface; and
the first effective refraction surface and the second effective refraction surface are configured to refract light toward the central region of the lighting apparatus.

5. The lighting apparatus of claim 4, wherein:
the first effective refraction surface forms an angular range of 40° from a first reference point toward a center point of the first lens;
the second effective refraction surface forms an angular range of 50° from a second reference point toward a center point of the second lens;
the first reference point corresponds to an intersection point between the first refraction surface and a first plate portion of the optical device; and
the second reference point corresponds to an intersection point between the second refraction surface and a second plate portion of the optical device.

6. The lighting apparatus of claim 5, wherein:
the first plate portion is provided between the central region and the first lens; and
the second plate portion is provided between the first lens and the second lens.

7. The lighting apparatus of claim 4, further comprising:
light diffusing particles disposed on the first refraction surface and the second refraction surface,
wherein the light diffusing particles are disposed outside the first effective refraction surface and the second effective refraction surface along a radial direction of the optical device.

8. The lighting apparatus of claim 1, wherein:
the first beam angle of the first lens with respect to a first center line is different from the second beam angle of the second lens with respect to a second center line;
the first centerline extends in a direction from a center of an LED of the first LED array through a center of the first lens; and
the second centerline extends in a direction from a center of an LED of the second LED array through a center of the second lens.

9. The lighting apparatus of claim 1, wherein:
the first beam angle of the first lens with respect to a first center line is different from the second beam angle of the second lens with respect to a second center line; and
the first center line and the second center line extend in a parallel direction with each other.

10. A lighting apparatus, comprising:
a base;
a first light emitting device (LED) array disposed on the base;
a second LED array disposed on the base; and
an optical device disposed on the base, the optical device comprising:
a first lens covering the first LED array, the first lens comprising:
a first incidence surface configured to receive light radiated from the first LED array; and
a first refraction surface configured to refract light propagating from the first incidence surface; and
a second lens covering the second LED array, the second lens comprising:
a second incidence surface configured to receive light radiated from the second LED array; and
a second refraction surface configured to refract light propagating from the second incidence surface,
wherein a first beam angle of the first lens and a second beam angle of the second lens are different from each other by independently controlling radii of the first incidence surface and the first refraction surface, and radii of the second incident surface and the second refraction surface, respectively.

11. An optical device, comprising:
a first lens portion;
a second lens portion;
a first plate portion provided between the first lens portion and the second lens portion,
wherein a beam angle of the first lens portion and a beam angle of the second lens portion are different from each other.

12. The optical device of claim 11, wherein:
the first lens portion is configured to cover a first light source, the first lens portion comprising:
a first incidence surface configured to receive light radiated from the first light source; and
a first refraction surface configured to refract light propagating from the first incidence surface; and
the second lens portion is configured to cover a second light source, the second lens portion comprising:
a second incidence surface configured to receive light radiated from the second light source; and
a second refraction surface configured to refract light propagating from the second incidence surface.

13. The optical device of claim 12, wherein the second beam angle of the second lens portion is greater than the first beam angle of the first lens.

14. The optical device of claim 12, wherein:
the first refraction surface comprises a first effective refraction surface;
the second refraction surface comprises a second effective refraction surface; and
the first effective refraction surface and the second effective refraction surface are configured to refract light toward a central region of the first plate portion.

15. The optical device of claim 14, wherein:
the first effective refraction surface corresponds to a portion of the first refraction surface with an angular range of 40° from a first reference point; and
the second effective refraction surface corresponds to a portion of the first refraction surface with an angular range of 50° from a second reference point.

16. The optical device of claim 15 further comprising a second plate portion provided between the central region and the first lens portion, wherein:
the first reference point corresponds to an intersection point between the first refraction surface and the first plate portion of the optical device; and
the second reference point corresponds to an intersection point between the second refraction surface and the second plate portion of the optical device.

17. The optical device of claim 15, further comprising:
light diffusing particles disposed on the first refraction surface and the second refraction surface,
wherein the light diffusing particles are disposed outside the first effective refraction surface and the second effective refraction surface along a radial direction of the optical device.

18. The optical device of claim 17, wherein a size of the light diffusing particles is less than or equal to 20 μm.

19. The optical device of claim 11, wherein the first plate portion comprises:
a first thickness at a first reference point, wherein the first plate portion and the first lens portion are connected to each other at the first reference point; and
a second thickness at a second reference point, wherein the first plate portion and the second lens are connected to each other at the second reference point,
wherein the first thickness is different from the second thickness.

20. The optical device of claim 19, wherein the first thickness is greater than the second thickness.
